(19) United States
(12) Patent Application Publication
(10) Pub. No.: US 2013/0031760 A1
(43) Pub. Date: Feb. 7, 2013

(54) METHOD FOR TESTING MOLDING SURFACE OF MOLD

(71) Applicant: ZIH-WEI WANG, Tu-Cheng (TW)

(72) Inventor: ZIH-WEI WANG, Tu-Cheng (TW)

(73) Assignee: HON HAI PRECISION INDUSTRY CO., LTD., Tu-Cheng (TW)

(21) Appl. No.: 13/490,464

(22) Filed: Jun. 7, 2012

(30) Foreign Application Priority Data
Aug. 1, 2011 (TW) 100127161

(51) Int. Cl. B23P 6/00

(52) U.S. Cl. 29/402.01

(57) ABSTRACT

A method for analyzing a surface of a mold includes the following steps. First, a high-power microscope is provided which includes an object platform, an objective lens, a coarse adjustment knob, and a fine adjustment knob. Second, the mold is positioned on the object platform. Third, the coarse adjustment knob is adjusted until a recognizable but blurred image of the molding surface is observed. Four, the fine adjustment knob is adjusted until a clear or the clearest image is observed. Five, the mold may be subject to repair and re-inspection, or the mold is taken off the object platform and declared satisfactory.

### BACKGROUND

1. Technical Field

The present disclosure generally relates to a testing method, and particularly to, a method for close analysis of a molding surface of a mold.

2. Description of Related Art

Camera modules are widely used in electric devices. A camera module typically includes a lens module and an image sensor received in a lower end of the lens module. Light passing through the lens module reaches the image sensor, such that an image is recorded by the image sensor. Quality of the lens module directly effects quality of the camera module, and quality of the lens module is directly effected by the lenses received in the lens module. The lenses are usually manufactured by an injection molding method or an imprinting molding method. In the injection molding method or the imprinting molding method, a mold having a geometrically-perfect surface is needed, and quality of the lenses is directly affected by the molding surface of the mold.

However, many flaws (e.g. tiny cutter marks) on the molding surface cannot be seen by the naked eye. Quality of lenses made by the molding surface with flaws is thus lower.

What is needed, therefore, is a method for analyzing a molding surface of a mold to overcome the above-described problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a perspective view of a mold waiting analysis according to an exemplary embodiment, the mold including a molding surface.

FIG. 2 is a block diagram of a high-power microscope for analyzing the molding surface of the mold of FIG. 1.

FIG. 3 is a flow chart of a method of analyzing the molding surface of the mold of FIG. 1 using the high-power microscope of FIG. 2.

### DETAILED DESCRIPTION

Embodiments will be described with reference to the drawings.

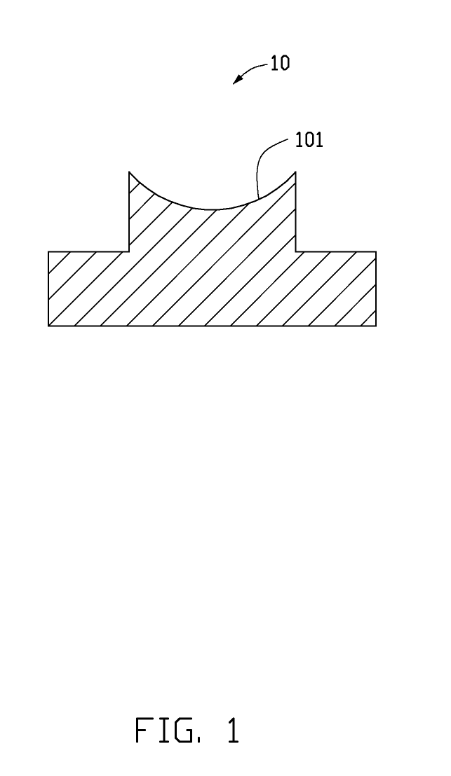

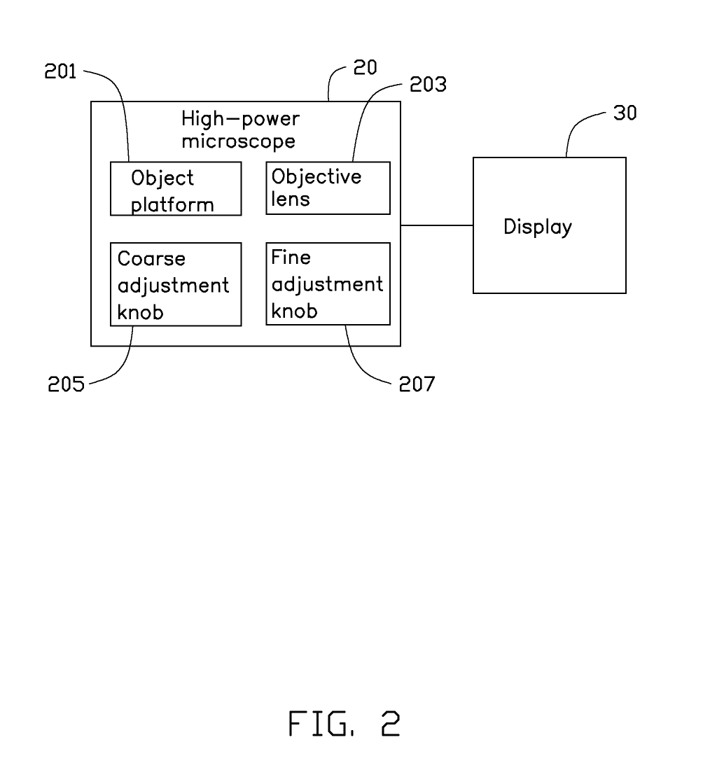

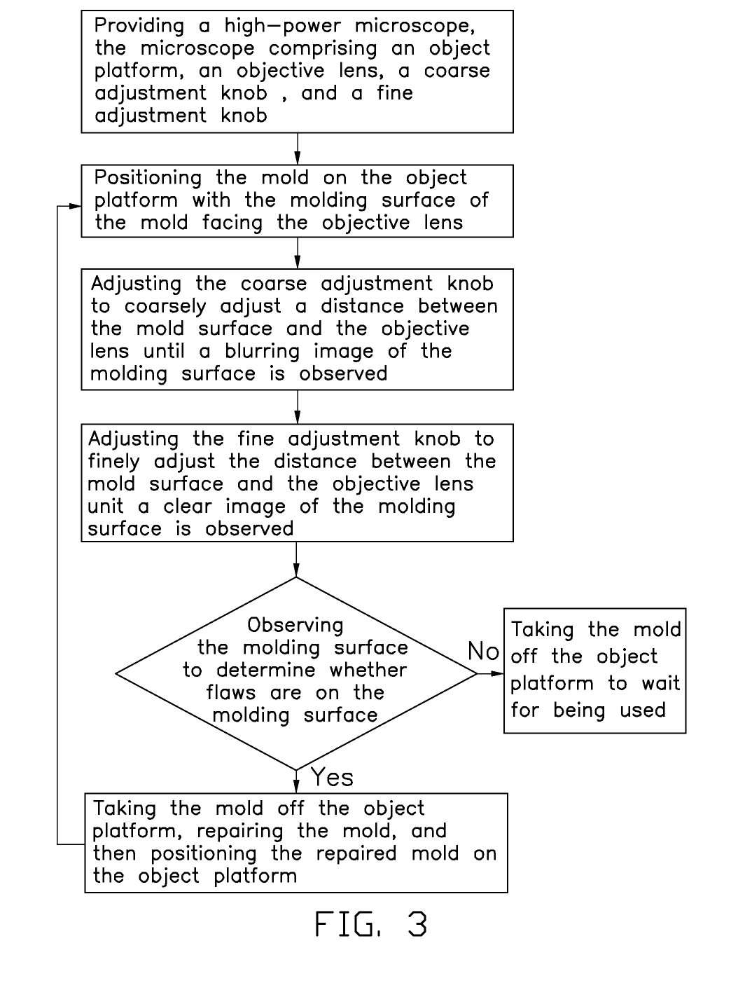

Referring to FIGS. 1-3, a method for analyzing a molding surface 101 of a mold 10, in accordance with an exemplary embodiment, includes the following steps.

In step 11, a high-power microscope 20 is provided. The high-power microscope 20 is a microscope having a magnification equal to or higher than 500, for example, or 600 or 700. The microscope 20 includes an object platform 201, an objective lens 203 opposite to the object platform 201, a coarse adjustment knob 205 for coarsely adjusting a distance between the object platform 201 and the objective lens 203, and a fine adjustment knob 207 for finely adjusting the distance between the object platform 201 and the objective lens 203.

In step 12, the mold 10 is positioned on the object platform 201 with the molding surface 101 facing the objective lens 203.

In step 13, the coarse adjustment knob 205 is adjusted to coarsely adjust the distance between the objective lens 203 and the molding surface 101 until a blurring image of the molding surface 101 is observed.

In step 14, the fine adjustment knob 207 is adjusted to finely adjust the distance between the objective lens 203 and the molding surface 101 until a clear, or the clearest, image of the molding surface 101 is observed.

In step 15, if flaws on the molding surface 101 are observed, the mold 10 is taken off the object platform 201, the area with the flaws of the molding surface 101 can be repaired, and then the repaired mold surface 101 can be positioned on the object platform 201 to be detected.

In step 16, if there is no flaw on the molding surface 101, the mold 10 is taken off the object platform 201 and declared to be satisfactory. Then, the mold 10 can wait for being used to making lenses (not shown).

In the present embodiment, for easily observing the molding surface 101, the high-power microscope 20 is connected to a display 30. The high-power microscope 20 transmits an image of the molding surface 101 to the display 30, and the display 30 shows the image of the molding surface 101. Analysis of the molding surface 101 is thus done more expediently and can be easily observed by a plurality of people.

In the method of detecting the molding surface 101 of the mold, the molding surface 101 is detected by a high-power microscope 20 with a magnification equal to or higher than 500, such that flaws on the molding surface 101 can easily and quickly be detected. Quality of the mold 10 and thus the quality of the lenses (not shown) made by the mold 10 can thus be improved.

While certain embodiments have been described and exemplified above, various other embodiments will be apparent from the foregoing disclosure to those skilled in the art. The disclosure is not limited to the particular embodiments described and exemplified but is capable of considerable variation and modification without departing from the scope and spirit of the appended claims.

What is claimed is:

1. A method for detecting a molding surface of a mold, comprising:
providing a high-power microscope, the microscope comprising an object platform, an objective lens opposite to the object platform, a coarse adjustment knob for coarse-adjusting a distance between the object platform and the objective lens, and a fine adjustment knob for fine-adjusting the distance between the object platform and the objective lens;
positioning the mold on the object platform with the molding surface of the mold facing the objective lens;
adjusting the coarse adjustment knob to coarsely adjust a distance between the mold surface and the objective lens until a blurring image of the molding surface is observed;
adjusting the fine adjustment knob to finely adjust the distance between the mold surface and the objective lens unit a clear image of the molding surface is observed;
taking the mold off the object platform, repairing the mold, and then positioning the repaired mold on the object platform to be detected if flaws on the molding surface are observed; and
taking the mold off the object platform to wait for being used if there is no flaw observed.

2. The method of claim 1, wherein the high-power microscope is connected to a display for displaying the clear image of the molding surface.

3. The method of claim 1, wherein magnification of the high-power microscope is 500, 600, or 700.
